(19) United States
(12) Patent Application Publication
(10) Pub. No.: US 2026/0227320 A1
(43) Pub. Date: Aug. 6, 2026

(54) CORROSION DETECTION FOR AN AQUEOUS FLUID REACTOR

(71) Applicant: AQUARDEN TECHNOLOGIES APS, Skævinge (DK)

(72) Inventor: Zhuoyan CAI, Skævinge (DK)

(21) Appl. No.: 19/154,088

(22) PCT Filed: Feb. 8, 2024
(86) PCT No.: PCT/EP2024/053176

§ 371 Date: Aug. 6, 2025

(30) Foreign Application Priority Data
Feb. 8, 2023 (EP) 23155619.2

(51) Int. Cl. G01N 17/00

(52) U.S. Cl. CPC G01N 17/006

(57) ABSTRACT

The present invention relates to an aqueous fluid reactor. The reactor comprising a corrosion detection element comprising a pipe element having a fluidic dead end. The pipe element extends a distance inside a reactor volume at which a dead end is provided. The pipe element is at a lower end fluidic connected to an inflow or an outflow line, and a sensor is provided configured and arranged to sense a flow, if present, in an interior of said pipe element.

### FIELD OF THE INVENTION

The present invention relates to an aqueous fluid reactor. The reactor comprising a corrosion detection element comprising a pipe element having a fluidic dead end. The pipe element extends a distance inside a reactor volume at which a dead end is provided. The pipe element is at a lower end fluidic connected to an inflow or an outflow line, and a sensor is provided configured and arranged to sense a flow, if present, in an interior of said pipe element.

### BACKGROUND OF THE INVENTION

Treatment of an aqueous fluid comprising organic and/or inorganic material, by gasification and/or oxidation at a pressure and a temperature being elevated relatively to e.g. standard atmospheric conditions has proven to be an effective way of e.g. decomposing hazardous chemical substances contained in the aqueous fluid. The gasification and/or oxidation is(are) typically carried out in a reactor being configured to withstand the elevated pressure and temperature, and such a reactor is typically made from metal, such as a metal alloy, defining a reactor volume in which the chemical reactions occur.

Due to the nature of the chemical reactions and/or reactants fed into the reactor volume, such oxygen, a corrosive environment inside the reactor may emerge and be present either constantly or intermittent. Such a corrosive environment may (depending on the choice of materials) has a destructive effect on the material(s) from which the reactor is made and/or on components located inside the reactor volume.

If corrosion occurs, e.g. in a reactor wall enclosing the reactor volume, this may jeopardize the structural integrity of the reactor wall, e.g. to such an extend that the reactor wall may rupture resulting in leakage of the fluid and reduction of the pressure inside the reactor volume. Further, it is common that the pressure inside the reactor volume may be above 220 bars and in such use cases, a rupture of the reactor wall may become dangerous to personnel standing close by.

Accordingly, it may be considered necessary to determine whether corrosion has taken place or is taken place inside the reactor volume to be able to proactive react on such corrosion.

Today, corrosion is detected e.g. by dismantling the reactor and perform a visual inspection. Clearly, this is a tedious and labour consuming method which has the further disadvantage that the reactor is out of service during such inspection. Another option available is to take out samples of fluid from the reactor volume and analyse the sample for traces of corrosion. While sampling and analysis can be carried out without taking the reactor out of service, it may be highly difficult to detect corrosion by such a procedure and the level of corrosion is considered non-estimable.

Hence, an improved way of detecting corrosion inside a reactor volume would be advantageous, and in particular a more efficient and/or reliable way of detecting corrosion inside a reactor volume would be advantageous.

### OBJECT OF THE INVENTION

It is an object of the present invention to provide an improved way of detecting corrosion inside a reactor volume.

It is a further object of the present invention to provide an alternative to the prior art.

In particular, it may be seen as an object of the present invention to provide a method and device that solves the above mentioned problems of the prior art with regard to corrosion detection.

### SUMMARY OF THE INVENTION

Thus, the above described objects and several other objects are intended to be obtained in a first aspect of the invention by providing an aqueous fluid reactor adapted to contain in a reactor volume an aqueous fluid, the reactor comprising:
a reactor body defining said reactor volume;
a fluid inlet arranged for inletting into said reactor volume at least said aqueous fluid, said fluid inlet is fluidicly connected to an inflow line being positioned externally of said reactor body;
a treated fluid output connection having an inlet in fluidic communication with said reactor volume, and being fluidicly connected to an outflow line being positioned externally of said reactor body;
a corrosion detection element comprising
   a pipe element having a fluidic dead end, said pipe element extends a distance inside said reactor volume at which said dead end is provided, wherein said pipe element at a position opposite to said dead end is fluidic connected, either directly or indirectly through an adapter section, to said inflow or outflow line or to a reservoir by a connecting pipe extending external of said reactor body,
a sensor configured and arranged to sense a flow, if present, in an interior of said pipe element.

Herein “treated fluid” preferably refers to an aqueous fluid containing organic and/or inorganic material and having undergone either partly or fully an oxidation and/or gasification process.

“sense a flow” preferably refers to detecting that a fluid has entered into the pipe element from the reactor volume though one or more corrosion generated through going openings in the pipe element. Such an entering fluid may typically have a temperature and/or a conductivity (and/or other characteristic(s)) being different from a fluid present in the pipe element prior to occurrence of one or more corrosion generated through going openings. Such an entering fluid may also contain corrosion products typically not contained in the fluid present in the pipe element prior to occurrence of one or more corrosion generated through going openings. A conductivity sensor, a temperature sensor or a sensor sensing specific corrosion products, or other sensors, would when the flow is initiated into the interior of the pipe element provide a change in read-out when the fluid flows into the pipe element. After the flow is initiated, the sensor readout may be unchanged over time, depending on the fluid flowing into the interior of the pipe element and the sensor type used. However, when a flow has been detected, this is indicative of corrosion and as the invention relates to detecting of corrosion, the sensor readout after a flow has been detected, is of less importance. This also applies to a reversed flow situation, where a fluid flow flows from the interior of the pipe element through corrosion generated through going openings into the reactor volume. Accordingly, “sense a flow” preferably refers to detecting that an inflow into the interior of the pipe element or detecting an that outflow from the interior of the pipe element into the reactor volume has occurred.

“sense a flow” also refers to either direct sensing of a flow by e.g. a flow sensor or indirect sensing a flow. Indirect sensing preferably refers to sensing a change in one or more fluid properties (other than velocity or flow). A change in a fluid properties could be one or more of conductivity, salt composition, corrosion products, viscosity, temperature, COD (chemical oxygen demand), turbidity, pH and/or pressure which can be measured by a suitable sensor.

By the pipe element being connected to the inflow or outflow line one or more of the following non-exhaustive list of advantages may be achieved:
When corrosion has taken place to an extent penetrating the wall of the pipe element, this will not result in a larger pressure drop inside the reactor. Thereby, the reactor may be kept in operation and shut-down in controlled manner for service.
A minimal, such as substantially, no pressure drop across wall of pipe element greatly reduces mechanical stress on the pipe element. This may provide the advantage that a mechanical failure, such as a fatigue failure, which could give rise to a false corrosion detection is greatly reduced. In addition, the risk of a collapse of the pipe wall is greatly reduced allowing for a smaller thickness of the wall of the pipe elements allowing for an earlier detection of corrosive species in the fluid, as the time it take for the corrosion to penetrate the wall is correlated with the thickness of the wall.
As the pipe element may be simultaneously flooded internally and in contact externally with the aqueous fluid entering or the treated fluid exiting the reactor volume, the corrosion rate is faster allowing for an earlier detection of corrosive species in the fluid as such species are contacting both the inner side and outer side of the pipe element.
Corrosion of pipe element simply results in an additional flow directly from or to the inflow or outflow line and does not result in leaks into the surroundings.
There need for a leakage containment via a separate reservoir is dispensed with.
Leakage onto material previously not in direct contact with the reactor fluid for corrosion detection may be prevented.

“at least an interior layer” as used inter alia in connection with “at least an interior layer of said reactor body is made from a first metal” preferably includes that the reactor body may made from said first metal, or that the first material is applied inside of the reactor body to form at least a part of an inner surface of said reactor.

In a second aspect, the invention relates to a method of detecting corrosion in an aqueous fluid reactor, said method comprising:
providing an aqueous fluid reactor according to the first aspect of the invention further comprising an electronic control unit connected with said sensor to receive sensor readout for said sensor;
   wherein said control unit is configured to determine based on said received sensor readout a change in said sensor readout, and in response to said determined change generating an output representing that corrosion has been detected.

### BRIEF DESCRIPTION OF THE FIGURES

The present invention and in particular preferred embodiments thereof will now be described in more details with regard to the accompanying figures. The figures show ways of implementing the present invention and are not to be construed as being limiting to other possible embodiments falling within the scope of the attached claim set.

FIG. 1 schematically illustrates a first embodiment of an aqueous fluid reactor; the reactor is illustrated in a cross sectional view to render the interior components visible;

FIG. 2 schematically illustrates a second embodiment of an aqueous fluid reactor; the reactor is illustrated in a cross sectional view to render interior components visible;

FIGS. 3A and 3B schematically illustrate an embodiment of a corrosion detection element in a cross sectional view; FIG. 3A illustrates the corrosion detection element not being corroded, whereas FIG. 3B illustrates the corrosion detection element being corroded;

FIG. 4 schematically illustrates a third embodiment of an aqueous fluid reactor; the reactor is illustrated in a cross sectional view to render interior components visible;

FIG. 5 schematically illustrates a fourth embodiment of an aqueous fluid reactor; the reactor is illustrated in a cross sectional view to render interior components visible;

### DETAILED DESCRIPTION OF AN EMBODIMENT

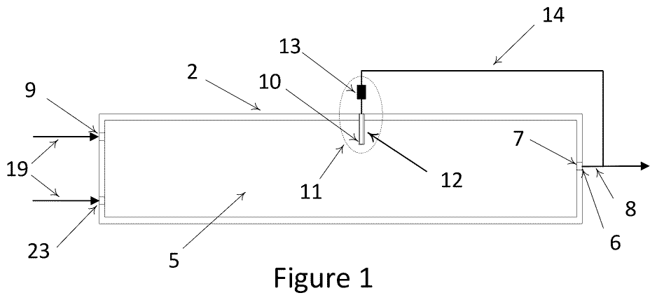

Reference is made to FIG. 1 schematically illustrating a first embodiment of an aqueous fluid reactor 1. The reactor 1 is adapted to contain in a reactor volume 5 an aqueous fluid and the reactor comprises a reactor body 2 defining the reactor volume 5 inside the reactor body 2. By adapted to contain is typically meant that the choice of materials and the dimensioning of the reactor 1 are made to withstand prevailing thermodynamical conditions, fluid dynamic conditions and/or chemical conditions during use of the reactor.

A fluid inlet 9 is arranged for inletting into the reactor volume 5 at least the aqueous fluid. In the embodiment illustrated in FIG. 1, the fluid inlet 9 is arranged at an elevated position, however, the fluid inlet 9 may be arranged differently. The fluid inlet 9 is fluidicly connected to an inflow line 19 being positioned externally of said reactor body 2.

Inside the reactor volume 5, one or more chemicals reactions take place involving the fluid inlet through the fluid inlet 9. The fluid being the result of the chemical reactions is typically referred to as a treated fluid. To outlet the treated fluid, the reactor has a treated fluid output connection 6 having an inlet 7 in fluidic communication with said reactor volume 5. In the embodiment illustrated in FIG. 1, the treated fluid output connection 6 is arranged centrally in a wall of the reactor body 2 downstream (the fluid flows from inlet 9 to output connection 6) of the fluid inlet 9. The treated fluid output connection 6 is fluidicly connected to an outflow line 8 being positioned externally of the reactor body 2.

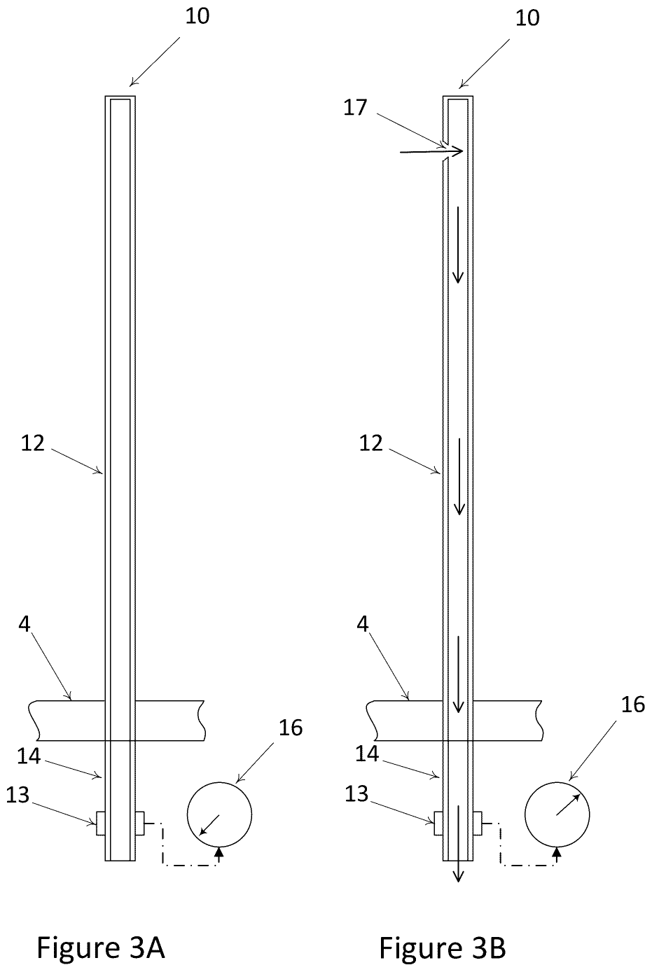

A corrosion detection element 11 is arranged to detect if corrosion takes place inside the reactor volume. Such a corrosion may occur in or on the reactor wall 2, or in or on other components arranged inside the reactor volume. A corrosion may occur due to the relative harsh environment inside the reactor volume during or being the result of the chemical reactions, or due to the fluid inlet is capable of introducing corrosion. The overall concept of the corrosion detection element 11 is that in comprises a hollow member being in fluid communication with the exterior of the reactor 1, so that if corrosion occurs in the hollow member a fluid may flow through the hollow member and to the exterior of the reactor. Such a flow of fluid is considered to show that corrosion has taken place inside the reactor not only corroding the hollow member but also that corrosion has taken place in or on other parts of the reactor 1. The overall concept will be disclosed in greater details below and in particular with reference to FIGS. 3A and 3B.

In the embodiment shown in FIG. 1, the corrosion detection element 11 has a pipe element 12 with a fluidic dead end 10 (a hollow member as disclosed above). The pipe element 12 may in preferred embodiments of the invention also be referred to as a tubular element with a fluidic dead end 10.

The pipe element 12 extends a distance inside the reactor volume 5 at which the dead end 10 is provided. The pipe element 12 is at a position opposite to the dead end fluidic connected, either directly or indirectly through an adapter section, to inflow or outflow line 8 by a connecting pipe 14 extending external of the reactor body 2. In the embodiment shown in FIG. 1, the pipe element 12 is fluidic connected to the outflow line 8.

By fluidicly connecting the pipe element 12 to the inflow line or the outflow line 8, the pressure inside the pipe element 12 may be at least in the same order of pressure as inside the reactor volume which may prevent collapsing of the pipe element and at the same time allow for fluid flowing from the reactor volume 5 into the pipe element ends up in the fluid flowing into or out from the reactor volume 5. At the same time, a flow of fluid into the reactor volume through the pipe element 5 is rendered possible which also can be used to detect corrosion.

It is noted that the pipe element 12 in general preferably is connected to a pressure being either slightly larger or smaller than the pressure inside the reactor volume 5 to allow for flow of fluid through the pipe element 12.

Although it may be preferred to fluidicly connect the pipe element 12 to an inflow line 19 and/or an outflow line 8, the pipe element 12 may in alternative embodiments be fluidicly connected to a reservoir (not illustrated). In some embodiments, the reservoir is having a pressure being smaller than the pressure in the reactor volume 5 whereby the presence of a through-going opening in the pipe element results in an increased pressure in the reservoir, which can be detected by a pressure sensor. In some embodiments, the reservoir may be pressurized to the pressure being slightly less than the pressure in the reactor volume 5 whereby larger pressure differences across the wall of the pipe element 12 inside the reactor volume may be reduced to avoid mechanical strain on the pipe element.

A flow in the pipe element 12 provides in the connecting pipe 14 a change in one or more fluid dynamic properties, such as a volume flow, and/or in or more or more thermodynamic properties, such as a change in temperature. Accordingly, a sensor 13 configured and arranged to sense a flow, if present, in an interior of the pipe element 12.

The principles disclosed in connection with FIG. 1 are also applicable in connection with the following embodiments.

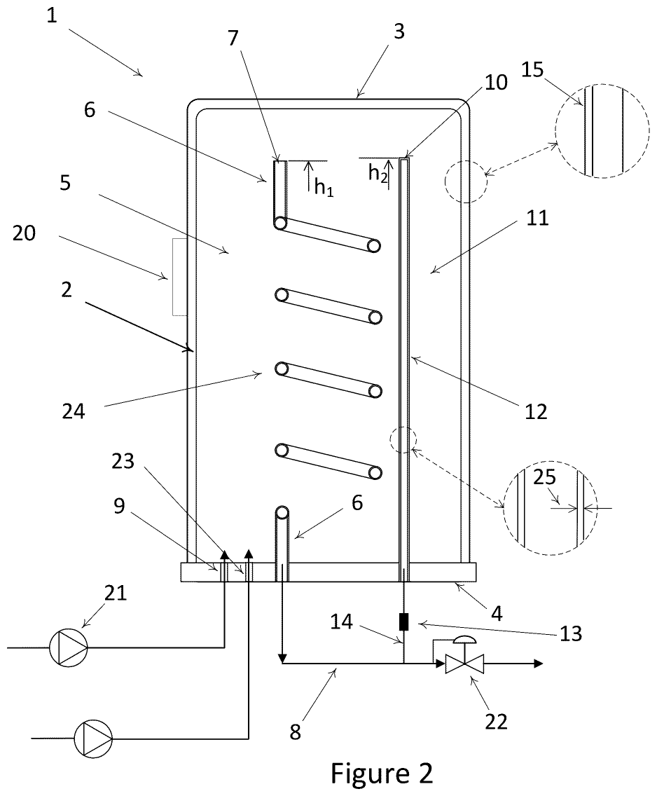

Reference is made to FIG. 2 schematically illustrating another embodiment of an aqueous fluid reactor 1. The reactor is illustrated in a cross sectional view, and fluid lines being arranged externally to the reactor, are drawn as single lines, although in a practical implementation such external fluid lines have a dimension. The reactor is cylindrical, but may have other shapes as long as the reactor defines a reactor volume 5.

The reactor 1 is adapted to contain inside the reactor 1 an aqueous fluid at elevated pressure and temperature during which an oxidation and/or gasification occurs. By adapted to contain is typically meant that the choice of materials and the dimensioning of the reactor 1 are made to withstand prevailing pressures and temperatures during the oxidation and/or gasification.

The aqueous fluid to be oxidized and/or gasified typically comprises organic and/or inorganic material, and the choice of materials for the reactor is typically also selected to be resistant, at least to a certain degree, to the organic and/or inorganic materials, as well as reactants formed during oxidizing and/or gasification and/or oxidizing agent(s) if introduced into the reactor.

In the following, the oxidizing and/or gasification process(es) are referred to in a non-limiting manner as treatment and the result of undergoing the treatment either fully or partly is referred to as treated.

As illustrated in FIG. 2, the illustrated reactor has a reactor body 2 in the form of an elongate tubular element. The reactor body 2 is closed at its upper 3 and lower 4 ends thereby defining a reactor volume 5 inside the reactor body 2. In a preferred embodiment, the closing at the upper end 3 may be carried out by welding a top member to the reactor body 2 and the closing the lower end 4 may be carried out by fastening a bottom member in a releasable manner to the lower end 4, thereby providing a service entrance into the reactor 1 by releasing the bottom member.

A fluid inlet 9 is arranged for inletting into said reactor volume 5 the aqueous fluid to be brought into an elevated pressure and temperature and thereby being treated. In the illustrated embodiment, this fluid inlet 9 is placed at the lower end 4 of the reactor 1, but it may be placed in another position.

A treated fluid output connection 6 is arranged with an inlet 7 inside reactor volume 3. As illustrated, the treated output connection 6 extends inside the reactor volume 5 towards the lower end 4 where it is fluidic connected to an outflow line 8 being positioned externally of said reactor body 2. The positioning inside the reactor volume 5 of the inlet 7 is selected according to a particular treatment to be carried out. In some instances of treatment, the fluid to be treated may be seen as being divided into zones (typically vertically zones) where the treated fluid is present in one of these zones and other zones may be reaction zones. The positioning of the inlet 7 is preferably arranged in the zone where the treated fluid is or most likely is present. For instance, if the treatment involves a super critical treatment, the treated fluid will be present in an upper super critical zone, and the inlet 7 is accordingly placed in this zone. Is noted, that the positioning of the zones is controllable, e.g. by controlling a vertical temperature profile in the reactor volume 5, e.g. by heating/cooling elements.

The reactor also comprises, as illustrated, a corrosion detection element 11. The disclosed corrosion detection element 11 comprises a pipe element 12 having a fluidic dead end 10. By fluidic dead end is meant that the pipe element 12 is fluidic closed at the end forming the dead end to prevent influx of fluid. Further, the pipe element is also of a type preventing influx of fluid through the wall of the pipe element, unless (as will be detailed below) an opening is formed by corrosion. The pipe element 12 extends a distance inside the reactor volume 5 at which the dead end 10 is provided. As will become apparent from the following, the pipe element 12 is an element to be corroded (if corrosion occurs) and the distance the pipe element 12 extends is accordingly preferably selected so that it is at least likely that the pipe element 12 will be present in a region or zone inside the reactor volume 5 being corrosive. Thus, the distance may be a full length or width of the reactor volume 5 or may be a less length or width.

The pipe element 12 is at a lower end thereof fluidic connected, either directly or indirectly through an adapter section, to the outflow line 8 or any other outflow line, e.g. by a connecting pipe 14 extending external of said reactor body 2. Kindly observe that the external pipes or lines in FIG. 2 are illustrated as single lines, although they do have a dimension. In the embodiment shown in FIG. 2, a pressure regulating valve 22 is arranged in the outflow line 8 and the fluidic connection between the pipe element 12 and the outflow line 8 is made upstream of the pressure regulating valve 22. By this, the pressure inside the pipe element 12 and the pressure in the outflow line 8 may be kept substantially equal. A sensor 13 is configured and arranged to sense a flow, if present, in an interior of said pipe element 12.

The corrosion detection element 11 may be seen as forming an appendix being fluidic connected to the outflow line 8 and extending into the reactor volume 5. Thereby, if one or more openings are provided by corrosion in the corrosion detection element 11 inside the reactor volume 5, a flow of fluid will be provided from the interior of the reactor volume 5 through the interior of pipe element and into the outflow line 8, and such a flow is used to detect corrosion, as will be disclosed in the following with reference to FIGS. 3A and 3B. It is noted, that depending on the pressures prevailing, a flow of fluid may be provided in the opposite direction, that is from the outflow line into the pipe element 12 and into the reactor volume.

In general, since the corrosion detection element 11 detect corrosion by corrosion, the detection element, or at least the pipe element 12 is preferably replaceable. This could be provided e.g. by fastening the pipe element 12 to the lower end 4 by a threaded connected involving suitable seals.

FIG. 3A schematically discloses in a cross sectional view the pipe element 12. As illustrated, the pipe element 12 is fluidic connected to a connecting pipe 14 and a sensor is applied to the connecting pipe 14 (the position of the sensor varies typically based on the sensor type and preferred positioning). A gage 16 is illustrated to symbol a sensor readout. In the situation of FIG. 3A, no opening has been provided due to corrosion in the wall of the pipe element 12 and consequently no flow is present in the pipe element 12. In FIG. 3B, corrosion has made a through going opening 17 in the pipe element 12. It is noted that although FIG. 3B only discloses a single through going opening 17, more openings may be present and the outer surface of the pipe element may have numerous dents or the like made by corrosion.

Once a through going opening 17 is provided, fluid will flow from the reactor volume 5 into and through the interior of the pipe element 12 and into the connecting pipe 14 (or vice versa). This flow will be sensed by the sensor and the presence of a flow in the pipe element 12 determines that corrosion of the pipe element 12 has taken place, which is at least an indicator on that corrosion has taken place inside the reactor at other positions than at the pipe element 12. In some embodiment, the flow is the pipe element 12 is said to be decisive on that corrosion has taken place inside the reactor at other positions that at the pipe element 12.

It is noted that although the flow is disclosed as going from the interior of the reactor volume 5 and into the pipe element 12, a reversed flow situation may occur. However, although the sensor readout may be different in such a reversed flow situation, the mere presence of a flow in the pipe element determines that corrosion has taken place inside the reactor.

The presence of a flow in the pipe element 12 may result in different sense-able-changes, such a change in temperature as warm or colder fluid begins to flow through the pipe element 12 removing or adding heat at the position of the sensor. In one embodiment, the sensor 13 is a temperature sensor, and this temperature sensor may advantageously be arranged externally relatively to the reactor 1, although it may be arranged in other positions. Other types of useable sensors includes a flow sensor or a conductivity sensor. The various types of sensors may be combined into a single sensor to detect flow based on a number of different parameters. As illustrated, the sensor 13 may be arranged at or in the connecting pipe 14.

It may be beneficial to have the have the pipe element 12 to act as a “galvanic anode” and this may be accomplished by at least an interior layer 15 of the reactor body 2 is made from first metal, such as a first metal alloy and said pipe element 12 is made from second metal, such as a second metal alloy, preferably being a sacrificial metal, where the two metals are selected in accordance with an galvanic anode configuration to be obtained. In addition to that, the material of at least an interior layer 15 of the reactor body may be made from a corrosion resistant material protecting the interior of the reactor body from corrosion, whereby a corrosion detected can be ruled to essentially not having occurred on the interior layer 15.

However, it may also be advantageous to avoid the presence of a galvanic anode configuration (as such an anode may distort the detected presence of corrosion) and in such cases, the first and the second metals may be the same metal, such as the first metal alloy and the second metal alloy are the same metal alloy.

Corrosion is a process occurring during a period, and reduces the thickness of the wall of the pipe element 12 gradually. Further, corrosion is often more aggressive in some regions compared to other regions. To be able to detect corrosion with a period being sufficiently short to address that corrosion has taken place, or has taken place to a certain extent, the wall thickness 25 of the pipe element is selected accordingly. Non-limiting examples of wall thickness are a wall thickness 25 in order of millimetres, such as between 1.0 mm and 10.0 mm.

In some embodiments, the pipe element 12 is cylindrical typically extending straight into the reactor. However, the pipe element 12 may comprise at least a section being coiled, such as being helically coiled. The pipe element 12 may comprise at least a section of the pipe element 12 which is coiled around at least a section of the treated output connection 6. By such an intimate contact between the treated output connection 6 and the pipe element 12 is may be concluded that if corrosion is detected in the pipe element, it may be likely that the treated output connection 6 has been exposed to the same corrosive environment which may have corroded also the treated output connection 6.

In some use applications of the reactor, the aqueous fluid is heated during its presence in the reactor. The heating may be provided by chemical reactions being exothermic and/or heating may be added to the aqueous fluid. As shown in FIG. 2, the inlet 7 is placed at an elevated position (relatively to the bottom of the reactor volume 5) and this elevated position may coincide with a region in the reactor volume 5 having a higher temperature than the fluid at the bottom of the reactor volume 5. Thus, the treated fluid output connection 6 extending towards the bottom of the reactor volume 5 may advantageously be provided with a heat exchanger 24 allowing transfer of heat from the fluid flowing in the treated fluid output connection 6 to fluid surrounding the output connection 6.

In the embodiment illustrated in FIG. 2, the heat exchanger 24 is provided by a section of the treated fluid output connection 6 being coiled, such as helically coiled. Preferably, a pitch in between neighbouring coils is sufficiently large to allow for fluid passage in between the coils.

The heat exchanger 24 may be made either fully or partly made from a third metal, such as a third metal alloy. In preferred embodiments, the second and the third second metals are same the same metal, such as the second metal alloy and the third metal alloy are the same metal alloy. By this, the corrosion detection element may be used to detect corrosion in the heat exchanger 24 as occurring at least a similar corrosion rate as a corrosion rate of the pipe element (12). The first, the second and the third metal may be the same metal, such as the first metal alloy, the second alloy and the third metal alloy may be the same alloy.

If a need for heating the aqueous fluid contained inside the reactor is present, heating elements 20, preferably electrical heating element, may be arranged to heat the aqueous fluid when contained in said reactor volume 5. In the embodiment of FIG. 2 one such heating element 20 is disclosed as arranged on the outside of the reactor, although more than one heating element 20 typically is used and the positioning may be different, such as even arranged on the inside of the reactor.

The aqueous fluid is typically pumped into the reactor volume, and to serve this purpose, a pump arranged to pump 21 is arranged to pump the aqueous fluid into said reactor volume 5 through the fluid inlet 9, as illustrated in FIG. 2. The pump 21 may also be used to at least assist in pressurizing the aqueous fluid contained reactor volume 5, although pressurization may also occur due temperature increase occurring based on chemical reactions and/or addition of heat by one or more heating elements 20.

The pressure level inside the reactor volume may advantageously be set by the aqueous fluid reactor comprises a pressure regulating valve 22 arranged in the outflow line 8. Thereby, the pressure regulating valve regulates the pressure inside reactor volume 5. The pressure regulating valve is typically arranged at a position downstream of a position where the connecting pipe 14 fluidicly runs into the outflow line 8, as illustrated in FIG. 2.

It may be advantageously to be able to feed an oxidizing fluid into the reactor volume 5, for instance in situations where the aqueous fluid does not carry sufficient amounts of oxidizing agents. To this end, the aqueous fluid reactor may further comprise an oxidizing fluid inlet 23 for inletting an oxidizing fluid, such as oxygen or hydrogen peroxide, into the reactor volume 5. Although the oxidizing fluid inlet 23 can be placed at different position, it may from a practical point of view be preferred, that the oxidizing fluid inlet 23 is arranged at the lower end 4 of the reactor body 2. Alternatively, the oxidizing fluid inlet may be arranged at an upstream end of the reactor, where upstream here refers to the position where fluid is inlet through the fluid inlet 9. The fluid inlet (9) is preferably also arranged at the lower end 4, although it may be placed in different positions.

As illustrated in FIG. 2, the inlet 7 of the treated fluid output connection 6 is preferably arranged at a first vertical height h₁ where this first vertical height is a position being closer to the upper end 3 than to the lower end 4. By this, the inlet 7 is typically positioned inside the reactor volume 5 in a region where treated fluid is present. The aqueous fluid may be most corrosive before becoming a treated fluid, and the treated fluid may even be essentially non-corrosive. In accordance with this, pipe element 12 may be designed to extend inside the reactor volume 5 to a second vertical height h₂ so that said pipe element (12) spans essentially an entire height of the treated output connection (6). In preferred embodiments this may be disclosed as h₂ being larger than h₁. By this, the pipe element may be considered to extend in regions where corrosion is most likely to occur. In other embodiments, h₂ may be smaller than said first vertical height h₁.

In preferred embodiments, reactor body in the form of an elongate tubular element is arranged, during use, with a longitudinal extension parallel or substantially parallel to gravity. In regards to FIG. 2, gravity is pointing towards the bottom of the figure.

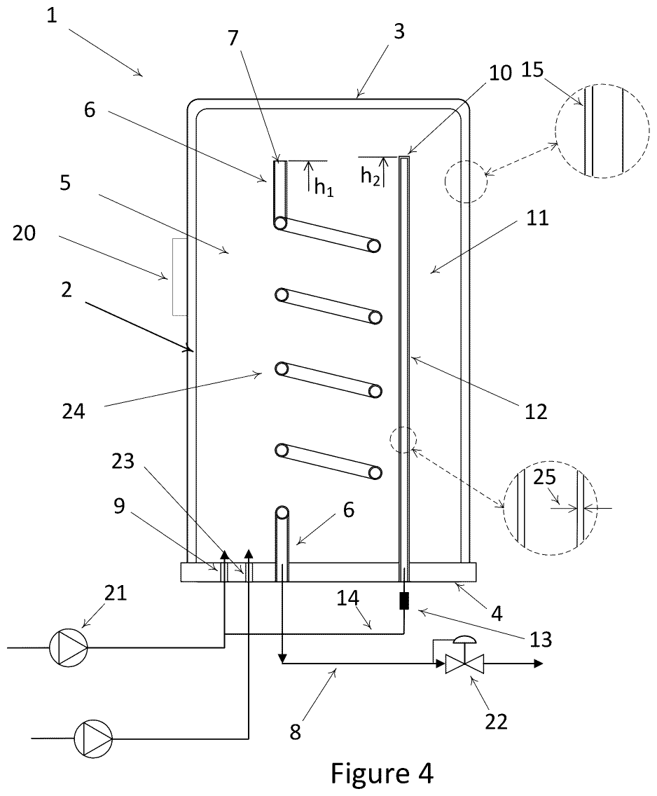

The embodiment shown in FIG. 4 shares the same features as the embodiment illustrated in FIG. 2 except that the connecting pipe 14 fluidicly connects the pipe element 12 with the fluid inlet 9.

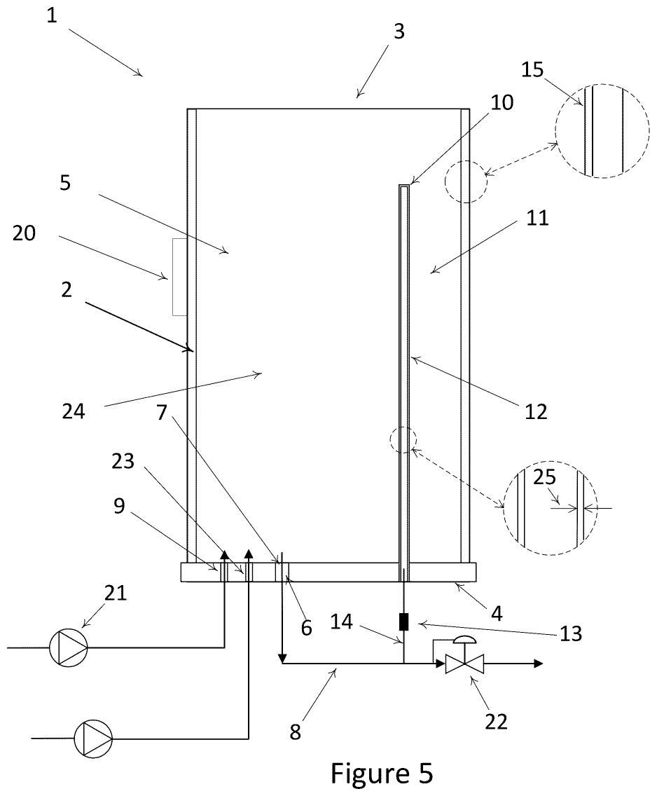

The embodiment shown in FIG. 5 share many of same features as the embodiment illustrated in FIG. 2 except the that reactor is an open ended reactor. In the illustrated embodiment, the reactor has an opening at the upper end 3. The heat exchanger 24 illustrated in FIG. 2 has been left out to indicate that the reactor in illustrated in FIG. 2 may be left out.

As the interior of the pipe element 12 is fluidic connected with either the inflow or outflow line, the interior may be filled or partly filled with the fluid flowing in the inflow of outflow line. During start-up of reactor, the interior of the pipe element 12 may contain or occupied by e.g. air. If it is desired to have the interior of the pipe element 12 filled with the fluid flowing in the inflow of outflow line, the flow lines, reactor and the interior of the pipe element 12 may be put under vacuum at start-up, whereby fluid from either the inflow or outflow line can flow into the interior of the pipe element 12. In some embodiments, the pressure inside the reactor volume is during use increased to such a high level, that gas, such as air, trapped in the interior of the pipe element 12 is compressed to a level where the interior of the pipe element is considered to be substantially filled with the fluid from the inflow or outflow line.

Preferred embodiments of the invention related to a method of detecting corrosion preferably in preferred embodiment of an aqueous fluid reactor. In such preferred methods, the reactor comprising an electronic control unit connected with the sensor 13 to receive sensor readout for said sensor. By the reactor comprising an electronic control unit is preferably meant that the reactor and control unit form a system where the control unit and the sensor is connected by e.g. electrical wire(s). The electronic control unit is typically a programmable unit having suitable converter(s) to convert the sensor readout into a digital format for use by a program running on the electronic control unit.

The control unit is typically configured to determine based on the received sensor readout a change in said sensor readout, and in response to said determined change generating an output representing that corrosion has been detected. The output may be a digital output (for receipt of a digital unit), an electrical signal, a language based output (understandable by a natural person), or other types of output.

In preferred embodiments, the output is converted, preferably by the electronic controller, into a visual and/or audible signal.

In preferred embodiments, output effectuates a shut-down of the aqueous fluid reactor, where the shut-down being either manually or automatically by the electronic control unit or another electronic control unit effectuated.

### ITEMIZED LIST OF PREFERRED EMBODIMENTS

Item 1. An aqueous fluid reactor (1) adapted to contain in a reactor volume (5) an aqueous fluid, the reactor comprising:
a reactor body (2) defining said reactor volume (5);
a fluid inlet (9) arranged for inletting into said reactor volume (5) at least said aqueous fluid, said fluid inlet (9) is fluidicly connected to an inflow line (19) being positioned externally of said reactor body (2);
a treated fluid output connection (6) having an inlet (7) in fluidic communication with said reactor volume (5), and being fluidicly connected to an outflow line (8) being positioned externally of said reactor body (2);
a corrosion detection element (11) comprising
   a pipe element (12) having a fluidic dead end (10), said pipe element extends a distance inside said reactor volume (5) at which said dead end (10) is provided, wherein said pipe element (12) at a position opposite to said dead end is fluidic connected, either directly or indirectly through an adapter section, to said inflow or outflow line (8) or to a reservoir by a connecting pipe (14) extending external of said reactor body (2),
   a sensor (13) configured and arranged to sense a flow, if present, in an interior of said pipe element (12).

Item 2. An aqueous fluid reactor according to item 1, wherein said sensor (13) is a temperature sensor.

Item 3. An aqueous fluid reactor according to item 1, wherein said sensor (13) is a flow sensor.

Item 4. An aqueous fluid reactor according to item 1, wherein said sensor (13) is a conductivity sensor.

Item 5. An aqueous fluid reactor according to item 1, wherein said sensor (13) senses specific corrosion products.

Item 6. An aqueous fluid reactor according to any one of the preceding items, wherein said sensor (13) is arranged at or in said connecting pipe (14).

Item 7. An aqueous fluid reactor according to any one of the preceding items, wherein at least an interior layer (15) of said reactor body (2) is made from a first metal, such as a first metal alloy and said pipe element (12) is made from a second metal, such as a second metal alloy, preferably being a sacrificial metal.

Item 8. An aqueous fluid reactor according to item 7, wherein the first and the second metals are same the same metal, such as the first metal alloy and the second metal alloy are the same metal alloy.

Item 9. An aqueous fluid reactor according to item 7, where the first and the second metals, such as the first and the second metal alloys, are selected so that pipe element (12) constitute a galvanic anode or sacrificial material.

Item 10. An aqueous fluid reactor according to any one of the preceding items, wherein a wall thickness (25) of said pipe element (12) is in order of millimetres, such as between 1.0 mm and 10.0 mm.

Item 11. An aqueous fluid reactor according to any one of the preceding items, wherein said pipe element (12) is cylindrical.

Item 12. An aqueous fluid reactor according to any one of the preceding items, wherein the pipe element (12) comprising at least a section being coiled, such as being helically coiled.

Item 13. An aqueous fluid reactor according to any one of the preceding items, wherein at least a section of the pipe element (12) is coiled around at least a section of the treated output connection (6).

Item 14. An aqueous fluid reactor according to any of the preceding items, wherein said treated fluid output connection (6) is provided with a heat exchanger (24), said heat exchanger being preferably provided by at least a section of said treated fluid output connection (6) being coiled, such as helically coiled, preferably with a pitch in between neighbouring coils to allow for fluid passage in between said coils.

Item 15. An aqueous fluid reactor according to any one of the preceding items, further comprising heating elements (20), preferably electrical heating element, arranged to heat said aqueous fluid when contained in said reactor volume (5).

Item 16. An aqueous fluid reactor according to any one of the preceding items, further comprising a pump arranged to pump said aqueous fluid into said reactor volume (5) through said fluid inlet (9).

Item 17. An aqueous fluid reactor according to any one of the preceding items, further comprising a pressure regulating valve (22) arranged in said outflow line (8) to regulate the pressure inside said reactor volume (5), said pressure regulating valve being arranged at a position downstream of a position where said connecting pipe (14) fluidicly runs into said outflow line (8).

Item 18. An aqueous fluid reactor according to any one of the preceding items, further comprising an oxidizing fluid inlet (23) for inletting an oxidizing fluid, such as oxygen or hydrogen peroxide, into said reactor volume (5), said oxidizing fluid inlet (23) is preferably arranged at said lower end (4) or at an upstream end of the reactor body (2).

Item 19. An aqueous fluid reactor according to any one of the preceding items, wherein said fluid inlet (9) is arranged at said lower end (4).

Item 20. An aqueous fluid reactor according to any one of the preceding items, wherein said inlet (7) of the treated fluid output connection (6) is arranged at a first vertical height (h₁).

Item 21. An aqueous fluid reactor according to any one of the preceding items, wherein the elongate tubular element is arranged, during use, with a longitudinal extension parallel or substantially parallel to gravity.

Item 22. An aqueous fluid reactor according to any one of the preceding items, when dependent on item 20, wherein said pipe element (12) extends inside said reactor volume (5) to a second vertical height (h₂) so that said pipe element (12) spans essentially an entire height of the treated output connection (6).

Item 23. An aqueous fluid reactor according to any one of the preceding items, wherein
said aqueous fluid reactor is adapted to contain inside the reactor said aqueous fluid at elevated pressure and temperature during which an oxidation and/or gasification occurs, said aqueous fluid comprising organic and/or inorganic material,
said reactor body is in the form of an elongate tubular element, the reactor body being closed at its upper and lower end thereby defining said reactor volume (5) inside said reactor body,
said fluid inlet is arranged for inletting into said reactor volume said aqueous fluid to be brought into said elevated pressure and temperature, and
said inlet (7) of said treated fluid output connection (6) is arranged inside said reactor volume, and said treated output connection (6) extends inside the reactor volume towards said lower end (4) wherein it is fluidicly connected to said outflow line (8).

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

### LIST OF REFERENCE SYMBOLS USED

1 Fluid oxidation reactor
2 Reactor body
3 Upper end (of reactor)
4 Lower end (of reactor)
5 Reactor volume
6 Treated fluid output connection
7 Inlet (of treated fluid output connection)
8 Outflow line
9 Fluid inlet
10 Dead end
11 Corrosion detection element
12 Pipe element
13 Sensor
14 Connecting pipe
15 Interior layer (of reactor body)
16 Gage
17 Through going opening (due to corrosion)
19 Inflow line
20 Heating element
21 Pump
22 Pressure regulating valve
23 Oxidizing fluid inlet
24 Heat exchanger
25 Wall thickness (of pipe element)
h₁ First vertical height
h₂ Second vertical height

1. An aqueous fluid reactor adapted to contain in a reactor volume an aqueous fluid, the reactor comprising:
a reactor body defining said reactor volume, at least an interior layer of said reactor body is made from a first metal;
a fluid inlet arranged for inletting into said reactor volume at least said aqueous fluid, said fluid inlet is fluidicly connected to an inflow line being positioned externally of said reactor body;
a treated fluid output connection having an inlet in fluidic communication with said reactor volume, and being fluidicly connected to an outflow line being positioned externally of said reactor body;
a corrosion detection element comprising
a pipe element made from a second metal, such as a second metal, having a fluidic dead end, said pipe element extends a distance inside said reactor volume at which said dead end is provided, wherein said pipe element at a position opposite to said dead end is fluidic connected, either directly or indirectly through an adapter section, to said inflow line or said outflow line by a connecting pipe extending external of said reactor body,
a sensor (13) configured and arranged to sense a flow, if present, in an interior of said pipe element.

2. An aqueous fluid reactor according to claim 1, wherein said sensor is a temperature sensor.

3. An aqueous fluid reactor according to claim 1, wherein said sensor is a flow sensor.

4. An aqueous fluid reactor according to claim 1, wherein said sensor is a conductivity sensor.

5. An aqueous fluid reactor according to claim 1, wherein said sensor senses specific corrosion products.

6. An aqueous fluid reactor according to claim 1, wherein said sensor is arranged at or in said connecting pipe.

7. An aqueous fluid reactor according to claim 1, wherein at least an interior layer of said reactor body is made from a first metal and said pipe element is made from a second metal being a sacrificial metal.

8. An aqueous fluid reactor according to claim 7, wherein the first and the second metals are same the same metal.

9. An aqueous fluid reactor according to claim 7, where the first and the second metals are selected so that pipe element constitute a galvanic anode or sacrificial material.

10. An aqueous fluid reactor according to claim 1, wherein a wall thickness of said pipe element is in order of millimetres.

11. An aqueous fluid reactor according to claim 1, wherein said pipe element is cylindrical.

12. An aqueous fluid reactor according to claim 1, wherein the pipe element comprising at least a section being coiled.

13. An aqueous fluid reactor according to claim 1, wherein at least a section of the pipe element is coiled around at least a section of the treated output connection.

14. An aqueous fluid reactor according to claim 1, wherein said treated fluid output connection is provided with a heat exchanger.

15. An aqueous fluid reactor according to clam 14, wherein said heat exchanger is made from a third metal.

16. An aqueous fluid reactor according to claim 15, wherein the second and the third second metals are same the same metal.

17. An aqueous fluid reactor according to claim 1, further comprising heating elements arranged to heat said aqueous fluid when contained in said reactor volume.

18. An aqueous fluid reactor according to claim 1, further comprising a pump arranged to pump said aqueous fluid into said reactor volume through said fluid inlet.

19. An aqueous fluid reactor according to claim 1, further comprising a pressure regulating valve arranged in said outflow line to regulate the pressure inside said reactor volume, said pressure regulating valve being arranged at a position downstream of a position where said connecting pipe fluidicly runs into said outflow line.

20. An aqueous fluid reactor according to claim 1, further comprising an oxidizing fluid inlet for inletting an oxidizing fluid into said reactor volume.

21. An aqueous fluid reactor according to claim 1, wherein said fluid inlet is arranged at said lower end.

22. An aqueous fluid reactor according to claim 1, wherein said inlet of the treated fluid output connection is arranged at a first vertical height.

23. An aqueous fluid reactor according to claim 1, wherein the elongate tubular element is arranged, during use, with a longitudinal extension parallel or substantially parallel to gravity.

24. An aqueous fluid reactor according to claim 1, wherein said inlet of the treated fluid output connection is arranged at a first vertical height and said pipe element extends inside said reactor volume to a second vertical height so that said pipe element spans essentially an entire height of the treated output connection.

25. An aqueous fluid reactor according to claim 1, wherein
said aqueous fluid reactor is adapted to contain inside the reactor said aqueous fluid at elevated pressure and temperature during which an oxidation and/or gasification occurs, said aqueous fluid comprising organic and/or inorganic material,
said reactor body is in the form of an elongate tubular element, the reactor body being closed at its upper and lower end thereby defining said reactor volume inside said reactor body,
said fluid inlet is arranged for inletting into said reactor volume said aqueous fluid to be brought into said elevated pressure and temperature, and
said inlet of said treated fluid output connection is arranged inside said reactor volume, and said treated output connection extends inside the reactor volume towards said lower end wherein it is fluidicly connected to said outflow line.

26. A method of detecting corrosion in an aqueous fluid reactor, said method comprising:
providing an aqueous fluid reactor according claim 1 further comprising an electronic control unit connected with said sensor to receive sensor readout for said sensor; wherein said control unit is configured to determine based on said received sensor readout a change in said sensor readout, and in response to said determined change generating an output representing that corrosion has been detected.

27. A method according to claim 26, wherein said output is converted, by said electronic controller, into a visual and/or audible signal.

28. A method according claim 26, wherein said output effectuates a shut-down of the aqueous fluid reactor, said shut-down being either manually or automatically effectuated by said electronic control unit or another electronic control unit.
